(19) United States
(12) Patent Application Publication
(10) Pub. No.: US 2006/0133887 A1
(43) Pub. Date: Jun. 22, 2006

(54) Combined resealable preservation bag/loose-leaf paper container

(76) Inventor: Ming-Tai Huang, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/021,814

(22) Filed: Dec. 22, 2004

(51) Int. Cl. B42F 13/00

(52) U.S. Cl. 402/79

(57) ABSTRACT

A combined resealable preservation bag/loose-leaf paper container includes a bag having two sheet materials four sides three of which are sealed, leaving an open side. A resealable strip device is mounted on the open side, allowing repeated opening and sealing of the open side. Holes are defined in one of the sealed sides of the bag, allowing the bag to be removably placed into a file folder as a loose-leaf paper container. The bag may further include a permanent sealed section extending from the open side. The permanently sealed section permanently seals the open side of the bag. The permanently sealed section may include a hole, forming a handle.

### BACKGROUND OF THE INVENTION

1. Field of the Invention

The present invention relates to a bag. In particular, the present invention relates to a resealable preservation bag.

2. Description of the Related Art

A typical resealable preservation bag includes two sheet materials with three sides of the sheet materials welded together, leaving an open side through which food can be put into the bag for preservation purposes. A resealable strip device is provided on the open side of the preservation bag, allowing repeated opening and repeated sealing of the bag. The preservation effect is however limited. To prolong the preservation effect, a permanent sealing section is provided outside the resealable strip device. Thus, a user must tear or cut the permanent sealing section away before opening the resealable strip device for reaching to the food in the resealable preservation bag. Some manufacturers use high-quality/high-cost materials for the bags and aesthetically appealing designs. The releasable preservation bags are however discarded after the food is consumed, causing a waste and polluting the environment.

### SUMMARY OF THE INVENTION

In accordance with the present invention, a combined resealable preservation bag/loose-leaf paper container is provided. The combined resealable preservation bag/loose-leaf paper container can be used as a releasable preservation bag for preserving food or a loose-leaf paper container for receiving documents.

The combined resealable preservation bag/loose-leaf paper container can be used as a releasable preservation bag for preserving food at first. After the food in the bag is consumed, the bag can be used as a loose-leaf paper container for receiving documents.

A combined resealable preservation bag/loose-leaf paper container in accordance with the present invention comprises a bag including two sheet materials four sides three of which are sealed, leaving an open side. A resealable strip device is mounted on the open side, allowing repeated opening and sealing of the open side. A plurality of holes are defined in one of the sealed sides of the bag, allowing the bag to be removably placed into a file folder as a loose-leaf paper container.

In an embodiment of the invention, the one of the sealed sides of the bag in which the holes are defined is opposite to the open side of the bag. In another embodiment of the invention, the one of the sealed sides of the bag in which the holes are defined is adjacent to the open side of the bag.

In an embodiment of the invention, the bag further includes a permanent sealed section extending from the open side. The permanently sealed section permanently seals the open side of the bag to prolong the preservation effect. The permanently sealed section may include a hole, forming a handle to allow easy carriage.

Preferably, the resealable strip device includes a groove portion on one of the sheet materials and a protruded portion on the other sheet material. The protruded portion is releasably engaging with the protruded portion for reopenably sealing the open side of the bag.

Preferably, the one of the sealed sides of the bag includes an extension outside a sealing line sealing the sealed sides, and the holes are defined in the extension.

Other objectives, advantages, and novel features of the invention will become more apparent from the following detailed description when taken in conjunction with the accompanying drawings.

### BRIEF DESCRIPTION OF THE DRAWINGS

FIG. 1 is a side view of a combined resealable preservation bag/loose-leaf paper container in accordance with the present invention.

FIG. 2 is a sectional view taken along plane 2-2 in FIG. 1.

FIG. 2A is an enlarged view of a circled portion in FIG. 2.

FIG. 3 is a perspective view illustrating use of the combined resealable preservation bag/loose-leaf paper container as a loose-leaf paper container.

FIG. 4 is a side view of a modified embodiment of the combined resealable preservation bag/loose-leaf paper container in accordance with the present invention.

FIG. 5 is a schematic side view illustrating opening of the combined resealable preservation bag/loose-leaf paper container in FIG. 4.

FIG. 6 is a perspective view illustrating use of the combined resealable preservation bag/loose-leaf paper container of the modified embodiment as a loose-leaf paper container.

### DETAILED DESCRIPTION OF THE PREFERRED EMBODIMENTS

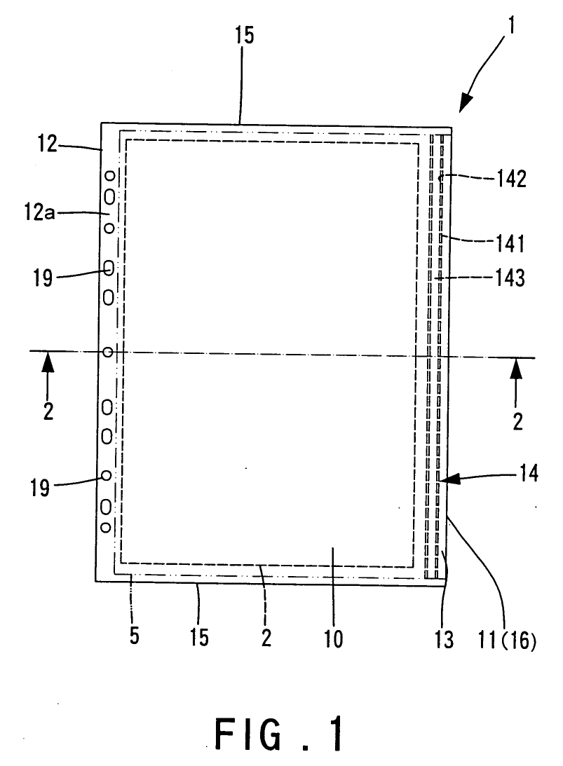

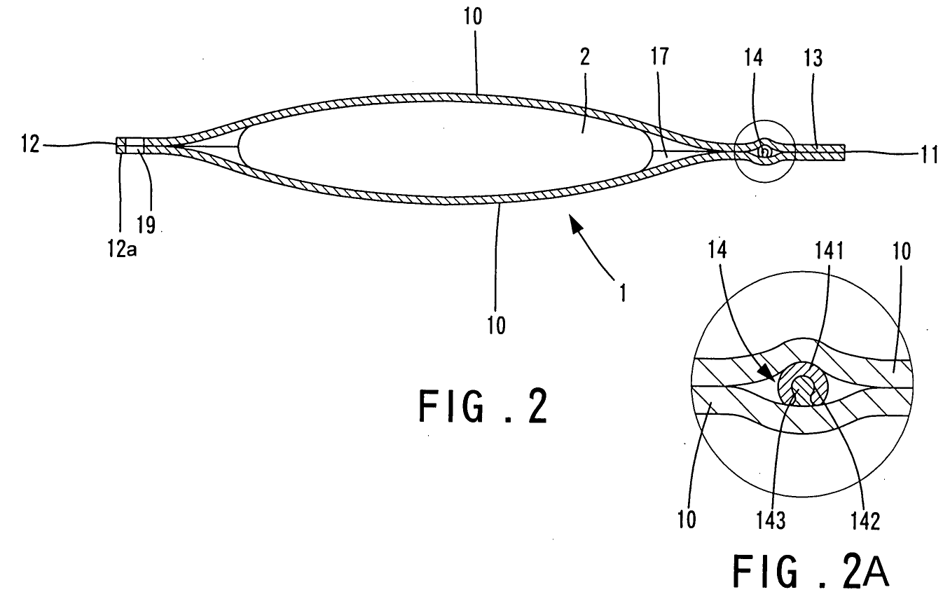

Referring to FIGS. 1 and 2, a combined resealable preservation bag/loose-leaf paper container (hereinafter referred to as “bag”) 1 in accordance with the present invention comprises two sheet materials 10 having three sides thereof bonded and sealed by, e.g., high-frequency welding or adhesive, leaving an open side 11 (the right one in FIG. 1) through which food, paper, or other articles can be put into a compartment 17 defined in the bag 1. In the illustrated embodiment, the sheet materials 10 are sealed along a sealing line 5 extending along a left side 12 and upper and lower sides 15 of the bag 1.

A resealable strip device 14 is mounted to the open side 11 of the bag 1. The resealable strip device 14 comprises a groove portion 141 on one of the sheet materials 10 and a protruded portion 143 on the other sheet material 10, as shown in FIGS. 2 and 2A. The protruded portion 143 is releasably engaged with a groove 142 of the groove portion 141, allowing repeated sealing and opening of the open side 11 of the bag 1. Namely, an opening 16 is formed when the protruded portion 143 is disengaged from the groove portion 141 through manual operation. An openable section 13 is thus provided on the open side 11 of the bag 1. Food, paper or other articles can be placed into the bag 1. Further, the open side 11 of the bag 1 is sealed when the protruded portion 143 is engaged with the groove portion 141 through manual operation, providing a sealed bag for preservation purposes. A resealable bag 1 is thus provided.

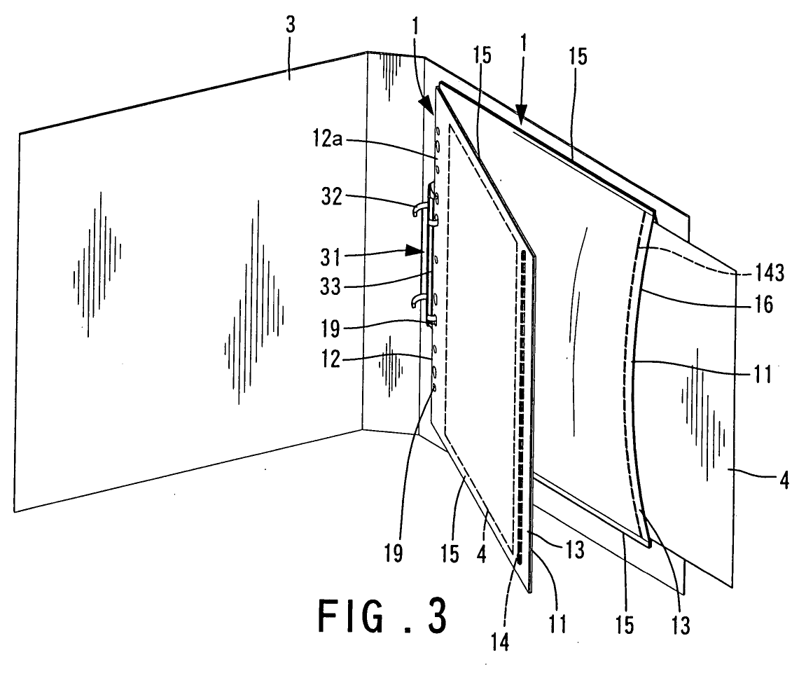

A plurality of holes 19 are defined in one of the sealed sides 12 and 15 of the bag 1 and located in an extension 12a outside the sealing line 5. In the illustrated embodiment, the holes 19 are defined in the extension 12a on the left side 12 of the bag 1, allowing the bag 1 to be used as a loose-leaf paper container. Referring to FIG. 3, a file folder 3 comprises a paper holding means 31 including, e.g., two paper extending members 32. The paper extending members 32 are extended through two of the holes 19, and a paper retaining member 33 is provided to fix the loose-leaf paper container 1 (i.e., the bag 1) in place. Paper 4 can be placed into the bag 1 via the opening 16 in the open side 11. The paper 4 is prevented from falling out of the loose-leaf paper container 1 when the resealable strip device 4 is in a sealed state.

Thus, the bag 1 in accordance with the present invention can be used as either a resealable preservation bag or a loose-leaf paper container, and reuse of the bag 1 is allowed. Namely, the bag 1 can be firstly used as a loose-leaf paper container for receiving documents or the like and then as a resealable preservation bag for preserving food or the like. Alternatively, the bag 1 can be firstly used as a resealable preservation bag for preserving food or the like and then as a loose-leaf paper container. In this case, cleaning of the bag 1 may be required. Nevertheless, cleaning of the bag 1 is not required, if the food is well wrapped or packaged.

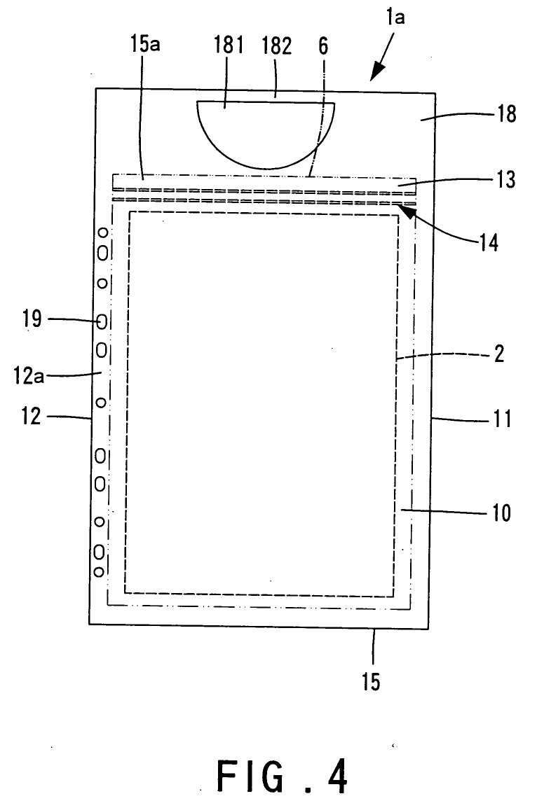

FIG. 4 illustrates a modified embodiment of the bag 1a in accordance with the present invention. In the illustrated embodiment, the open side is the top side 15a adjacent to the left side 12, forming an openable section 13. Similar to the first embodiment, a resealable strip device 14 is provided on the openable section 13, allowing repeated opening and sealing of the open side 15a. Further, the openable section 13 is permanently sealed. Namely, in this embodiment, four sides of the bag 1a are permanently sealed along a sealing line 6 extending along four sides 11, 12, 15, and 15a of the bag 1. A permanently sealed section 18 is formed outside the openable section 13. Thus, the bag 1a can be used as a preservation bag at first, in which the food in the bag 1a can be preserved for a relatively long period of time before the permanent sealing of the openable section 13 is destroyed. Further, the permanently sealed section 18 may include a hole 181, forming a handle 182 to allow easy carriage of the bag 1a.

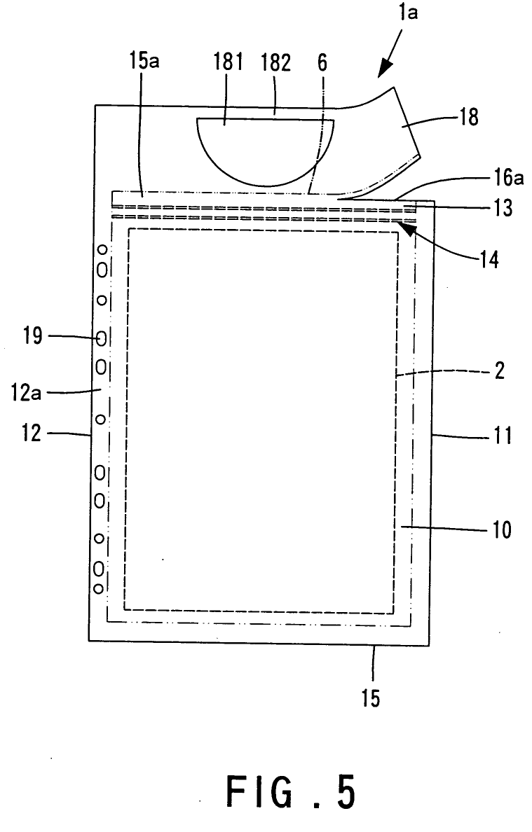

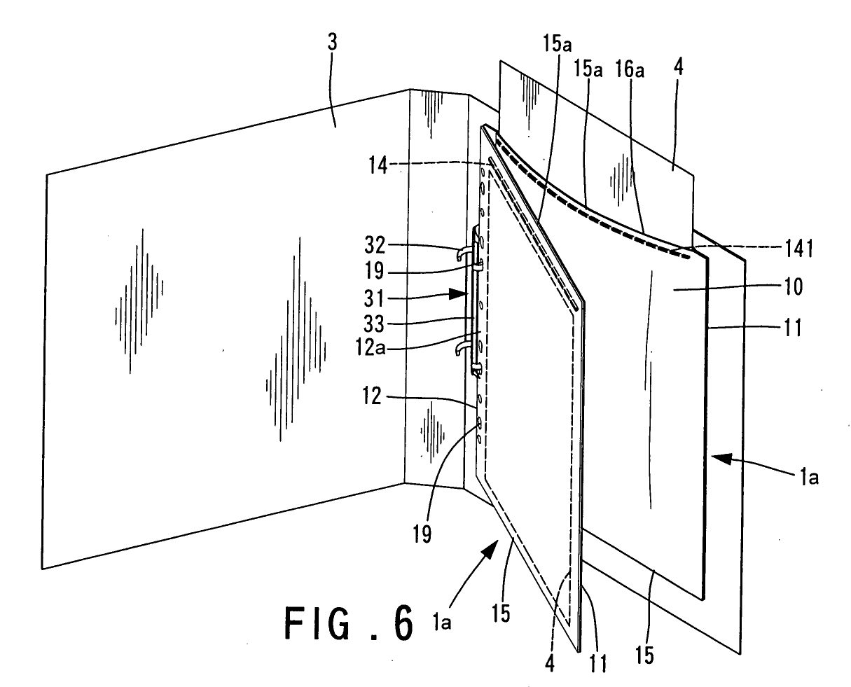

Referring to FIG. 5, the permanently sealed section 18 is cut or torn away along a line inside the sealing line 6, allowing access to the openable section 13. The resealable strip device 14 can be opened to reach the food in the bag 1a. After the food in the bag 1a is consumed, the bag 1a can be used as a loose-leaf paper container, as shown in FIG. 6. Paper 4, documents, etc can be placed into the bag 1a via the opening 16a that is formed when the resealable strip device 4 is opened.

It is noted that the bag 1, 1a can be used with various types of file folders when used as a loose-leaf paper container. The paper holding means of the file holders are not limited to the type shown in FIGS. 3 and 6.

Although specific embodiments have been illustrated and described, numerous modifications and variations are still possible without departing from the essence of the invention. The scope of the invention is limited by the accompanying claims.

What is claimed is:

1. A combined resealable preservation bag/loose-leaf paper container comprising:
a bag including two sheet materials four sides three of which are sealed, leaving an open side;
a resealable strip device mounted on the open side, allowing repeated opening and sealing of the open side; and
a plurality of holes defined in one of the sealed sides of the bag, the holes allowing the bag to be removably placed into a file folder as a loose-leaf paper container.

2. The combined resealable preservation bag/loose-leaf paper container as claimed in claim 1 wherein said one of the sealed sides of the bag in which the holes are defined is opposite to the open side of the bag.

3. The combined resealable preservation bag/loose-leaf paper container as claimed in claim 1 wherein said one of the sealed sides of the bag in which the holes are defined is adjacent to the open side of the bag.

4. The combined resealable preservation bag/loose-leaf paper container as claimed in claim 1 wherein the bag further includes a permanent sealed section extending from the open side, the permanently sealed section permanently sealing the open side of the bag.

5. The combined resealable preservation bag/loose-leaf paper container as claimed in claim 1 wherein the permanently sealed section includes a hole, forming a handle.

6. The combined resealable preservation bag/loose-leaf paper container as claimed in claim 1 wherein the resealable strip device including a groove portion on one of the sheet materials and a protruded portion on the other sheet material, the protruded portion being releasably engaging with the protruded portion for reopenably sealing the open side of the bag.

7. The combined resealable preservation bag/loose-leaf paper container as claimed in claim 1 wherein said one of the sealed sides of the bag includes an extension outside a sealing line sealing the sealed sides, and wherein the holes are defined in the extension.
